(19) United States
(12) Patent Application Publication
(10) Pub. No.: US 2025/0279686 A1
(43) Pub. Date: Sep. 4, 2025

(54) CONDUCTOR FOR AN ELECTRIC MACHINE

(71) Applicant: GKN Automotive Limited, Birmingham, West Midlands (GB)

(72) Inventors: Alberto Peña Rodriguez, Zumaia (ES); Jon García Urbieta, Zumaia (ES); Iñigo García Sierra, Zumaia (ES); Iago Martinez Ocaña, Zumaia (ES); Damian Leandro Tamburi, Zumaia (ES)

(21) Appl. No.: 18/862,618

(22) PCT Filed: May 13, 2022
(86) PCT No.: PCT/EP2022/063071

§ 371 Date: Nov. 4, 2024

(51) Int. Cl. H02K 3/24; H02K 3/22; H02K 3/28

(52) U.S. Cl. CPC H02K 3/24; H02K 3/22; H02K 3/28

(57) ABSTRACT

A conductor for an electric machine, comprising: a first winding element made of an electrically conductive material and having a channel through which a coolant can flow, wherein the first winding element is integrally formed with a first straight portion, a reverse portion and a second straight portion parallel to the first straight portion, wherein the first straight portion has a first end section and the second straight portion has a second end section; a hollow connecting member made of electrically conductive material; wherein the hollow connecting member and the first end section of the winding element are axially insertable into each other to form an axially overlapping electrical and fluidic connection. The disclosure further relates to an electric machine with such a conductor.

### TECHNICAL FIELD

The present disclosure relates to a hollow winding element for an electric machine. The electric machine can be any type of motor with a winding stator for example, a permanent magnet synchronous motor, an induction motor, an excited rotor synchronous motor or a switched reluctance motor. An electric motor is an electric machine which typically comprises a stator and a rotor. The stator carries windings connected to an alternating current (AC) power supply to produce a rotating magnetic field.

### BACKGROUND

Document US 2021/0249926 A1 discloses a coil bobbin attached to a stator core of a distributed winding radial gap-type rotating electric machine, and including a teeth holding portion and a slot insulator which are made of an insulator. The teeth holding portion has: a first wall surface that covers a first circumferential side surface of a tooth of the stator core; a second wall surface that covers at least a part of a second circumferential side surface of the tooth; and a third wall surface that covers both side surfaces in an axial direction of the tooth. The slot insulator is formed integrally with the first wall surface of the teeth holding portion, and has a plurality of through-holes extending in the axial direction and arrayed in a radial direction.

From DE 10 2020 114 683 A1, an active part for an electrical machine is known that comprises a current-conductive winding for generating a magnetic flux and an active part iron for holding the current-conductive winding for conducting the magnetic flux of the winding. The active part iron has a plurality of axially extending grooves over the circumference, in which the winding conductors are arranged. The winding conductors are formed as hollow conductors, thereby forming a cooling channel for a coolant for cooling the active part. The winding is designed as a wave winding with one-piece winding conductors.

From document US 2021 0091619 A1, corresponding to WO 2019 038139 A1, a winding piece is known which is to be inserted into one or more grooves of an electrical machine. The winding piece is in the shape of a hairpin, which are inserted into the grooves of the electrical machine. The winding piece comprises two limbs and a curved transition region, which connects the two limbs to each other. The limbs each have a first portion with a profile adjusted to the cross-section of the groove, and an end portion with a round profile. The winding piece is formed as a hollow conductor, which has a penetrating channel, through which a coolant can be led.

There are known some direct oil cooling solutions to cool down the winding of a PMSM. Normally, these solutions are focused on end windings, while the active winding inside the stator stack remains relatively far from any cooling sources. Thus, heat is higher on the active winding, with the conductor layer closest to the airgap contains the hotspot. Furthermore, there are some solutions for active winding cooling, but they all remain far from the hotspot though.

It is an object of at least some implementations of the present disclosure to propose a conductor for an electric machine with an effective cooling structure that can be produced easily and cost effectively. The object of at least some implementations is to propose an electric machine with such a conductor.

### SUMMARY

A conductor to be inserted into a slot of an electrical machine is proposed, comprising: a first winding element made of an electrically conductive material as a hollow conductor with a channel through which a coolant can flow, wherein the first winding element includes integrally formed a first straight portion, reverse portion and a second straight portion parallel to the first straight portion, wherein the first straight portion has a first end section and the second straight portion has a second end section; a hollow connecting member made of electrically conductive material; wherein the hollow connecting member and the first end section of the winding element are axially insertable into each other to form an axially overlapping electrical and fluidic connection. The first straight portion, reverse portion and second straight portion form one piece, i.e. they are portions of the same winding element. The winding element can be described to be hairpin-shaped.

An advantage of the conductor is that the hollow winding elements and hollow connecting members can serve as electric conductors with a coolant flow circulating inside them. The cooling fluid can be an oil, or oil based fluid, for example. A conductor composed of a plurality of winding elements and hollow members connecting them, can be fed with a cooling fluid so that the winding can be cooled down directly in the source of the heat losses that it generates. This is a very effective way to cool the winding as the loss generation center point is tackled.

A conductor is made of a plurality of single winding elements which can also be referred to as conductor elements or hair pin elements. Two winding elements are connected to each other via a respective connecting member. According to a first option, the connecting member may be a separate part that is introduced into both adjoining winding elements so as to obtain a mechanic, electrical and fluidic connection. The connection can be established very easy by a simple plug-in movement in axial direction. No further connecting means, such as welding, are necessary. The two winding elements are connected to each other on their straight portion with a connecting member that can also be referred to as tube or sleeve member. According to a second option, the connecting member may also be a portion of the second winding element. In this case, the first winding element and the second winding element are directly plugged into one another. The two connected winding elements are arranged in the same slot of the stator and may have the same layer span and/or bended geometry.

Another advantage is that the tube member and the winding element(s) can be easily connected with each other by a simple plug-in connection. As mentioned, no welding is required, thus reducing process and time costs. Furthermore, since the connection is arranged within the slot of the electric machine, the reverse portions of the winding elements can be shaped according to the requirements, with the overall length of the machine being particularly small.

The hollow connecting member can be connected to the first end section of the winding element with an interference fit. In this manner, a particularly secure mechanical, electrical and fluidic connection is achieved. However, it is understood that the connecting member and winding element could also be configured with a transition fit, or small play fit. An end portion of the tube member and/or the end face of the winding member can have a conical chamfer for easy insertion of the tube member into the bore of the winding member. The axial length of the tube member can be at least 0.1 times, in particular at least 0.2 times the length of the first straight portion of the winding element. This contributes to a safe connection.

According to an embodiment, the wall thickness of the tube member can be smaller than the wall thickness of the winding element.

The end section of the winding element can have a connecting bore that extends from the end face of the winding element to a stop face. The bore forms an interior hole that can be machined into the end section of the winding element so as to have a greater cross section than the channel of the winding element. Or, in other words, the inner diameter of the bore can be greater than the inner diameter of the channel of the winding element at a section adjoining the end section. The connecting tube can be inserted into the bore until it axially abuts the stop face of the winding element. Then, with its other end, the connecting tube can be inserted into the second winding element.

The outer diameter of the connecting member can be greater than the inner diameter of the channel of the winding element. The connecting member has a smallest inner diameter which, for example, can be greater than 0.9 times and/or smaller than 1.1 times a smallest inner diameter of the channel of the winding element. In this way, any change in cross section of the channel along the connection, and thus any pressure jump, is small. This contributes to a good flow of the cooling fluid through the channel. The cross section and/or diameter of the channel may be substantially constant along the connecting region between the tube and the winding elements so that a smooth flow is achieved.

The connecting member and/or the winding element can be produced from copper, aluminium, stainless steel or an alloy comprising at least one of copper, aluminium and stainless steel. The materials of the connecting member and the winding element may be selected such that a difference between the thermal expansion coefficient of the material of the connecting member and the thermal expansion coefficient of the material of the winding element is smaller than 10% of the friction coefficient of any one of the materials.

According to a first embodiment, a second winding element can be provided with the same structure as the first winding element, wherein the first winding element and the second winding element are connected with each other via the hollow connecting member. On one side, the connecting member is axially inserted into the first end section of the first winding element, and on the other side it is axially inserted into the second end section of the second winding element. The conductor can be composed of a plurality of first and second winding elements that are connected to each other via a plurality of connecting members, wherein the conductor forms a continuous cooling channel with an inlet and an outlet.

According to a second embodiment, the channel can comprise a plurality for first and second winding elements, with straight intermediate elements arranged therebetween. In this case, a first winding element can be connected via a hollow connecting member with a straight intermediate element, with one side of the hollow connecting member axially inserted into an end section of the first winding element and the other side of the hollow connecting member axially inserted into the straight intermediate element. The other end of the straight intermediate element is connected via another hollow connecting member to another winding element, and so on, to form a continuous conductor. Further details regarding the connections between the winding elements and the straight elements via the hollow connecting members can be configured as described above.

A cooling fluid can be supplied to the circuit on a terminal rack. The terminal rack can have blocks, instead of plates for terminal, which allows not only the inverter terminal connection but as well oil inlets. On the neutral points of the winding arrangement, the conductors can end in an open terminal, squirting the oil over the end windings and to the motor oil pool. Hydraulically, all parallels of all phases can be connected in parallel.

The above object may be achieved with an electric machine comprising a stator and a rotor, wherein the stator comprises a plurality of longitudinal slots distributed over the circumference, with a plurality of conductors being arranged in each one of the longitudinal slots of the stator for generating an electromagnetic field, wherein at least two of the plurality of conductors is configured according to any one of the embodiments described above. The slots extend in longitudinal, i.e. axial direction of the stator and can also be designated as grooves.

The advantages of the electric machine correspond the advantages described above in connection with the conductor. A direct cooling of the conductor core and/or heat source is achieved. This allows that the electric machine, assuming the same current density, can be operated at a lower temperature, thus reducing the deterioration of the insulation system. Accordingly, higher torque densities of the electric machine can be obtained for the same current densities. To achieve a maximum operating condition, the current of the cooling fluid can be increased, hence improving the continuous operation torque and speed envelopes, as well as higher peak torque and power.

According to an embodiment, the stator can comprise at least four conductors in each slot, wherein at least two of the plurality of conductors are configured to be solid conductors. In other words, the electric machine can be provided with a partial number of hollow conductors configured and a partial number of solid conductors. At least one hollow conductor may be arranged in each one of the slots of the stator. The connecting tubes of the plurality of conductors may be arranged in a center plane arranged between a first end face and an opposite second end face of the stator.

### BRIEF DESCRIPTION OF THE DRAWINGS

Certain embodiments are described below with reference to the drawings. Herein

FIG. 1A shows a conductor portion in a perspective view;

FIG. 1B shows two winding elements with a connecting member of FIG. 1A in an exploded view;

FIG. 1C shows the end section of a winding element of the conductor portion of FIG. 1A;

FIG. 1D shows the connecting region between two winding elements of the conductor portion of FIG. 1A;

FIG. 2A shows a connecting member of the conductor portion of FIG. 1A as a detail in an axial view;

FIG. 2B shows the connecting member of FIG. 2A in a side view;

FIG. 3A shows the conductor portion of FIG. 1A in an axially exploded view with a stator of an electric machine;

FIG. 3B shows the stator and conductor portion of FIG. 3A in an axial view;

FIG. 4 shows a conductor with a plurality of winding elements connected to each other to form a plurality of straight portions and reverse portions over the circumference;

FIG. 5A shows the conductor of FIG. 4 in a three dimensional exploded view with a stator of an electric machine;

FIG. 5B shows the inlet and outlet of the conductor of FIGS. 4 and 5A as a detail;

FIG. 5C shows the stator and conductor of FIG. 5A in a mounted condition in a three dimensional view;

FIG. 6 shows an electric machine with a plurality of conductors in an axial view;

FIG. 7A shows a conductor portions in second embodiment in a perspective exploded view;

FIG. 7B shows a group of conductor portions in a perspective exploded view;

FIG. 7C shows conductor with a plurality of first and second winding elements and intermediate elements in a perspective exploded view;

FIG. 8A shows a stator with plurality of conductor portions according to FIG. 7B in a in a perspective exploded view;

FIG. 8B shows the stator with the plurality of conductor portions according to FIG. 8A in a longitudinal sectional view; and

FIG. 8C shows the detail 8C of FIG. 8B in a larger view.

### DETAILED DESCRIPTION

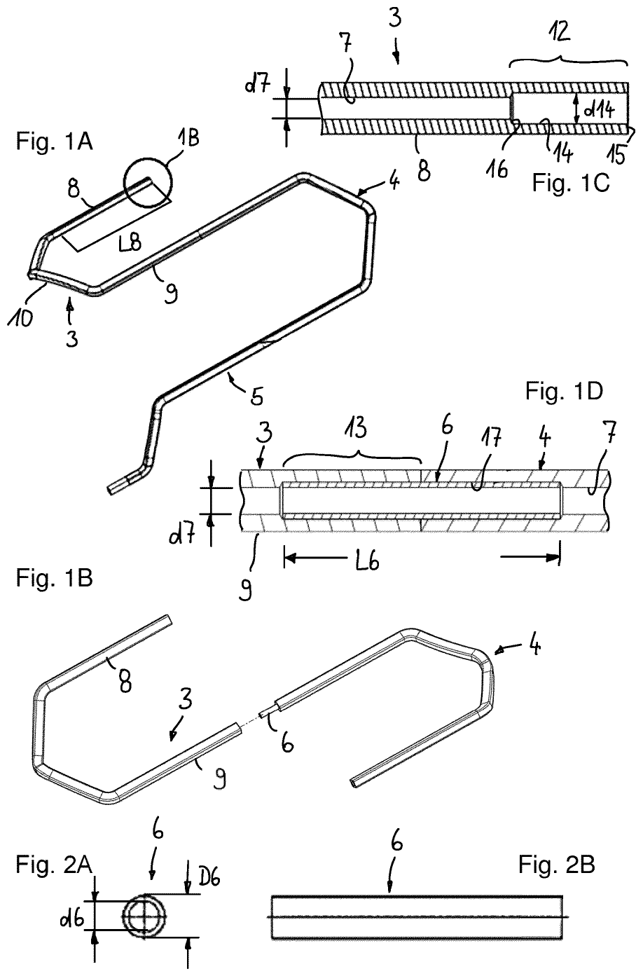

FIGS. 1A to 1D, which will be jointly described below, show a portion of a conductor 2. A conductor 2 is to be mounted in a plurality of circumferentially distributed slots of a stator of an electric machine (not shown here).

The conductor 2 comprises a plurality of winding elements 3, 4, 5 that are connected with each other via connecting members 6. A connecting member 6 is shown as a detail in FIGS. 2A and 2B and can also be referred to as tube or sleeve member. The winding elements 3, 4, 5 and connecting members 6 are made from an electrically conductive material. In a mounted condition, they form the hollow conductor 2 with a channel 7 through which a coolant can flow. Thus, the conductor 2 has two functions, namely conducting electrical current and conducting coolant.

The winding elements 3, 4 can be made from copper, aluminium, stainless steel or an alloy comprising at least one of copper, aluminium and stainless steel. The same applies for the material of the connecting members 6. The materials of the connecting member 6 and the winding element 3, 4 may be selected such that a difference between the thermal expansion coefficient of the material of the connecting members and the thermal expansion coefficient of the material of the winding elements is smaller than 10% of the friction coefficient of the materials of one of them.

As a representative of several winding elements 3, 4 for the stator, one winding element 3 is described in greater detail. A winding element 3 is hair-pin shaped, including a first straight portion 8, a second straight portion 9 parallel to the first straight portion, and a reverse portion 10 connecting the first and second straight portions 8, 9 with each other. As can be seen in FIGS. 1B and 1C, the first and second straight portions 8, 9 have a respective first and second end section 12, 13, into which a respective connecting member 6 can be axially inserted so as to connect to winding elements 3, 4 with each other. The connecting member 6 can be connected to the first and second winding elements 3, 4 with an interference fit. For easily introducing the connecting member 6 into the respective winding element 3, 4, any one of said elements may optionally have a conical chamfer. In the mounted condition, as shown in FIG. 1D, an axially overlapping mechanical, electrical and fluidic connection is formed by the elements 3, 4, 6. The axial length L7 of the connecting member 6 can be for example at least 0.1 times, which may be at least 0.2 times the length L8 of the first straight portion 8 of the winding element 3. Thus, a secure axial overlapping connection is obtained. The wall thickness of the connecting member 6 can be smaller than the wall thickness of the winding elements 3, 4, as can be seen in FIG. 1D.

The end section 12 of the winding element 3 has a connecting bore 14 that extends from the end face 15 of the winding element to a stop face 16. The bore 14 forms an interior hole that can be machined into the end section of the winding element 3 so as to have a greater cross section and/or diameter d14 than the cross section and/or diameter d7 of the channel 7 of the winding element. The stop face 16 can serve as a stop for the connecting member 6 to be inserted into the bore 14. The other end of the connecting member 6 is inserted into the bore of the adjacent winding element 4.

As can be seen in FIG. 1D, the outer diameter D6 of the connecting member 6 is greater than the inner diameter d7 of the channel of the winding elements 3, 4. The inner diameter d6 of the connecting member 6 substantially corresponds with the inner diameter d7 of the channel 7 of the winding elements, so that a good cooling flow is achieved without pressure drops. A ratio between the inner diameter d6 of the connecting member 6 and the inner diameter d7 of the channel 7 can be for example between 0.9 and 1.1, i.e. 0.9<d6/d7<1.1.

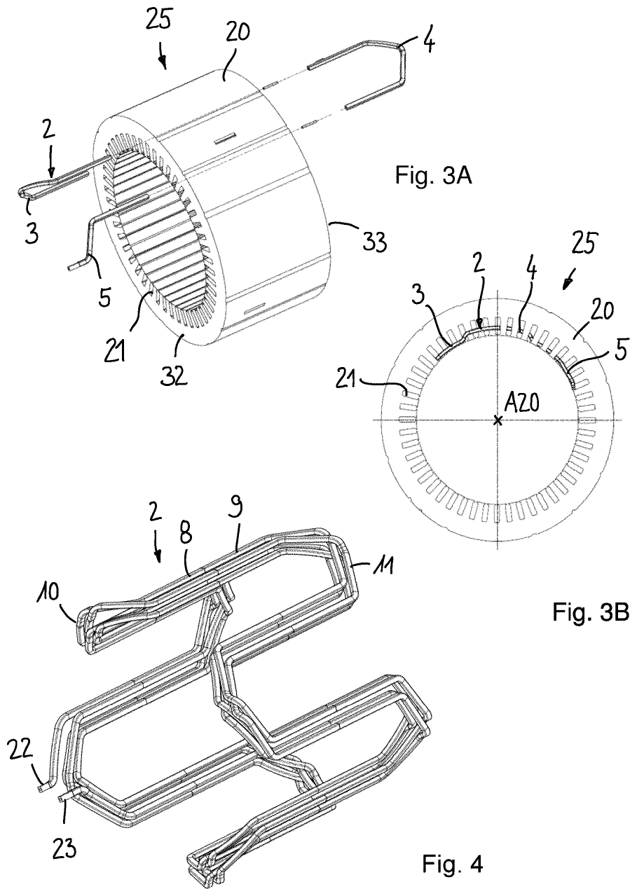

FIGS. 3A and 3B show the portion of the conductor 2 of FIG. 1A with the winding elements 3, 4, 5 together with a stator core 20 of an electric machine. The stator core 20 is generally ring-shaped around a stator axis A20, and comprises a plurality of slots 21 being distributed on an inner circumferential face 24 around the axis A20. The stator core 20 can be produced, for example, by laminating a plurality of electromagnetic steel sheets or soft magnetic materials. A complete conductor 2 being composed of a plurality of winding elements 3, 4, 5 and constituting one electric and fluidic channel is shown in FIG. 4. The conductor 2 shown here comprises 16 pairs of straight portions (8, 9) and reverse portions (10, 11) forming a meander-like structure over the circumference. The straight portions are to be arranged in respective slots 21 of the stator core 20, wherein in each slot a plurality of straight portions is received. The reverse portions 10, 11 are arranged axially adjacent to the stator core 20 and span a plurality of slots in circumferential direction. As can be seen in FIG. 4, each conductor 2 has an inlet 22 and an outlet 23 so that a cooling fluid can be supplied through the conductor circuit. The cooling fluid can be supplied to the circuit on a terminal rack (not shown).

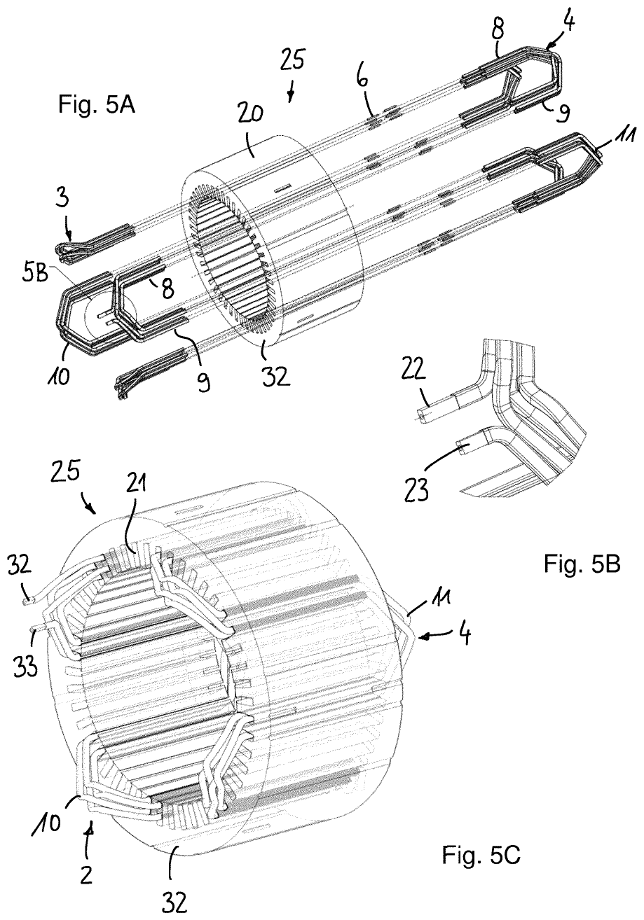

FIGS. 5A, 5B and 5C show the conductor 2 of FIG. 4 in combination with a stator core 20. The complete winding structure to constitute the complete stator of an electric machine can have 6 conductors 2 of the type shown in FIG. 4. However, it is understood that this number is only exemplary, and depending of the number of slots arranged over the circumference, and the number of conducting channels in each slots, the number of conductors may vary accordingly.

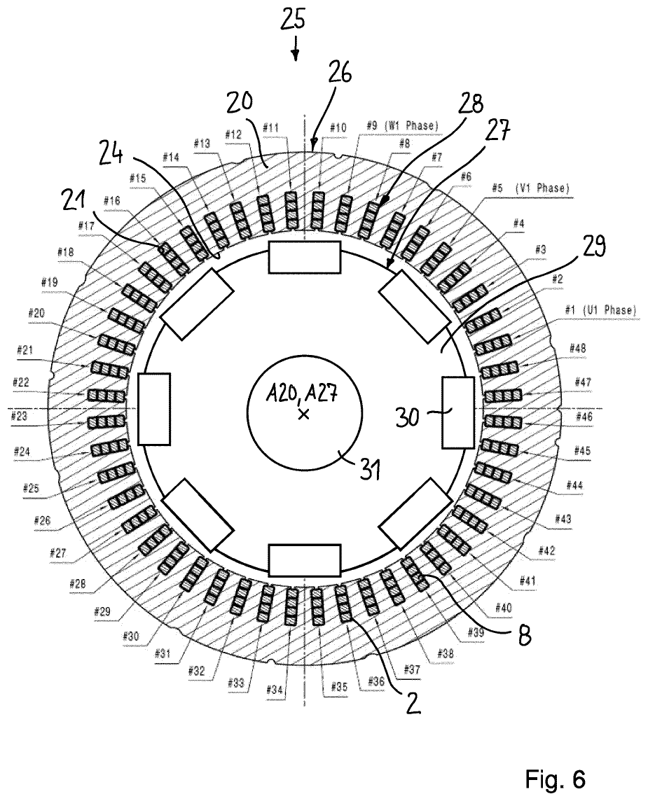

An electric machine 25 is shown in FIG. 6. The electric machine 25 comprises a stator 26 and a rotor 27 arranged coaxially thereto. The stator 26 includes the stator core 20 and the windings 28 composed of a plurality of conductors 2. The electric machine 25 is configured in the form of a permanent magnet synchronous machine (PMSM). The windings 28 are connected to an AC power supply to produce a rotating magnetic field. The rotor 27 comprises a rotor member 29 and a plurality of permanent magnets 30 embedded therein to create a constant magnetic field. In an activated condition, the rotor 27 is rotated about the axis of rotation A27 to drive a drive shaft 31 connected to the rotor member 29.

In this embodiment, the stator core 20 comprises a number of 48 slots 21 over the circumference, with a number of four conductor lines arranged in each slot 21. However, it is understood that these numbers are only exemplary, with stators with other numbers of slots and conductor lines being possible which can be selected according to the technical requirements.

The electric machine 25 including conductors 2 is advantageous in that the hollow winding elements 3, 4 and connecting members 6 can serve at the same time as electric conductors and cooling conductors. The conductors 2 can be fed with a cooling fluid so that the windings 28 can be cooled down directly where the heat is generated. The coolant can be fed by a high voltage connector and can exit at a neutral phase of the electric machine 25. The coolant can either be collected or extracted to the heat exchanger or it may be collected in a carter inside the electric machine, depending whether a wet or dry motor design is provided. The coolant may be fed on a given parallel winding. The coolant feeding may be implement at first, second, third or fourth parallel indistinctively for all the phases in the motor, ensuring a balanced neutral voltage.

Further advantages and special features are that the structure and construction is easy which is well compatible with mass production and thus very cost effective. The shaped hollow winding elements 3, 4 are connected both physically and electrically by means of the connecting members 6 that can robustly transfer the flow of coolant and electric current. The winding elements 3, 4 may touch axially to conduct current, in order to form a supplementary current path to the channel cross section. Other shapes may be considered in order to maximize current transfer path, for example a conical shape. As mentioned above, the connecting member 6 can be installed in a press fit configuration with the two hairpin halves, thus ensuring interference and aiming for perfect contact between the conductors 2 and the connecting sleeve. The manufacturing process is defined to allow easy assembly. The connecting members 6 can be located in the middle of the stator 25 or in a different position close to the end windings as required. In a modified embodiment, additional connecting sleeves may be implemented to apply existing winding elements 3, 4 forming equipment for different stack length. This may require for example two connections in the straight side of the winding elements 3, 4.

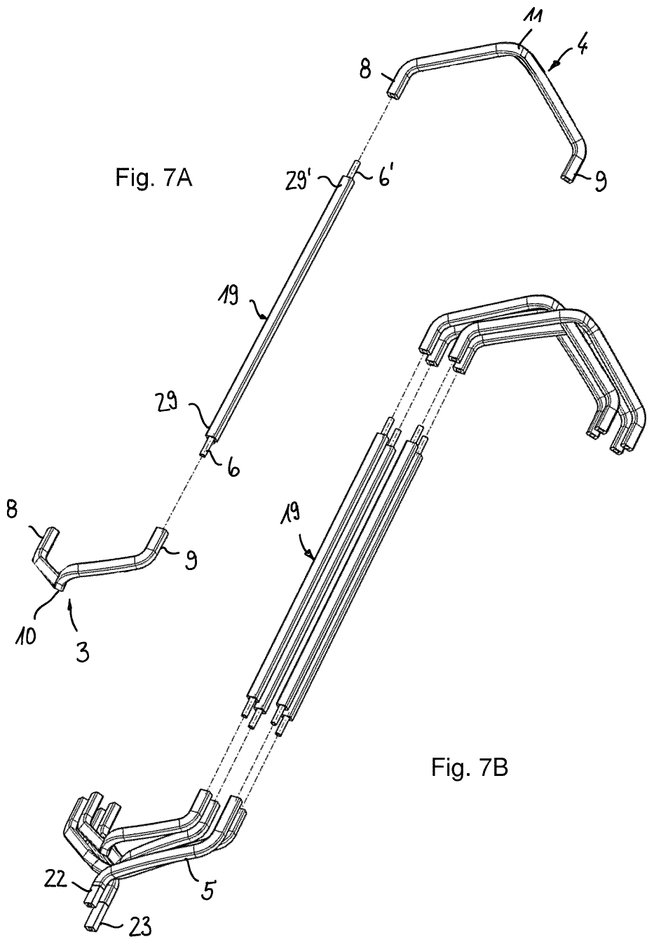

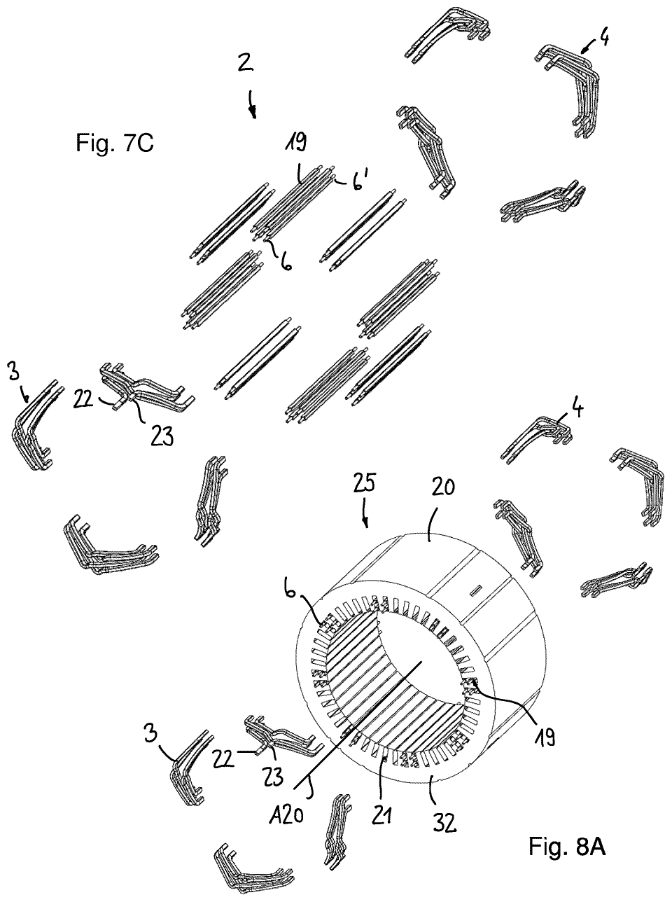

FIG. 7A shows a portion of a conductor 2 in a second embodiment. The conductor portion widely corresponds to the embodiment according to FIGS. 1 to 5 to which description it is hereby referred to with regard to similarities. The same or corresponding details are provided with the same reference signs as in the above Figures.

The conductor 2 comprises a plurality of winding elements 3, 4 that are connected with each other via an intermediate element 19 by means of connecting members 6, 6′. The winding elements 3, 4, the intermediate element 19 and the connecting members 6, 6′ are made from an electrically conductive material. In a mounted condition, they form a hollow conductor 2 with a channel 7 through which a coolant can flow.

A characterising feature of the embodiment according to FIG. 7A is that the conductor does not only include first and second winding elements 3, 4, but also includes straight intermediate elements 19 to be inserted in the slots of the stator. Accordingly, the straight portions 8, 9 of the first and second winding elements 3, 4 are shorter than in the first embodiment. Besides this, the structure and design of the winding elements 3, 4 corresponds to the above described embodiment according to FIGS. 1 to 5. An intermediate element 19 comprises a first end section 29 to be connected with an end section of a first winding element 3 via a first connecting member 6, and a second end section 29′ to be connected with an end section of a second winding element 4 via a second connecting member 6′. The connection between a winding element 3, 4 and the intermediate element 19 via a connecting member 6, 6′ is effected as described with respect to FIGS. 1 to 5 to which it is referred for brevity.

FIG. 7B shows a group of conductor portions which are to be connected to further conductor portions (not shown) to jointly form one single conductor for an electric machine.

FIG. 7C shows a conductor including a plurality of conductor portions in an exploded view. The conductor 2 is hollow and forms a channel 7 through which a coolant can flow. As in the above embodiment, the conductor 2 has two functions, namely conducting electrical current and conducting coolant. The conductor 2 has an inlet 22 and an outlet 23 so that a cooling fluid can be supplied through the conductor circuit.

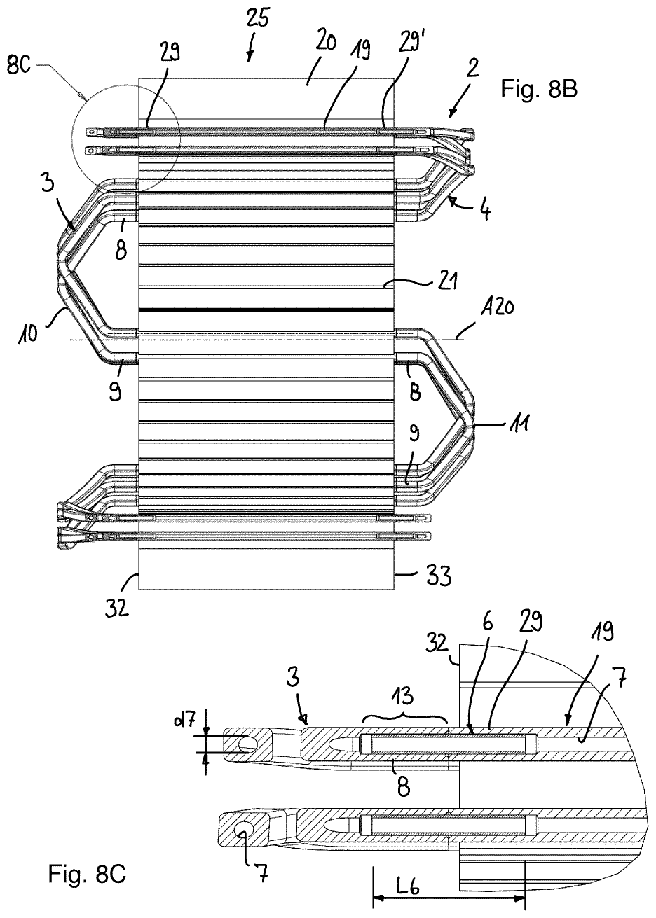

FIGS. 8A to 8C show the conductor 2 of FIG. 7C with the winding elements 3, 4 and intermediate elements 19, together with a stator core 20 of an electric machine. The stator core 20 is configured as described in the first embodiment to which description it is hereby referred, with the same or corresponding components being provided with the same reference signs. The conductor 2 shown here comprises 16 pairs of straight intermediate elements 11 which are connected with respective winding elements 3, 4 to form one channel 2 with a meander-like structure over the circumference. The straight intermediate elements 11 are arranged in respective slots 21 of the stator core 20, wherein a plurality of intermediate elements 11 is received in each slot 21. As can be seen in particular in FIGS. 8B and 8C, the intermediate elements 11 are axially longer than the axial extension of the stator core 20. The ends 34, 34′ of the straight elements protrude just beyond the end face 32, 33 of the stator core 20, in particular by less than half the length L6 of the connecting member 6, 6′.

The winding elements 3, 4 are arranged axially adjacent to the stator core 20 and span a plurality of slots 21 in circumferential direction. The inlet 22 and outlet 23 of the conductor 2 can be seen in FIG. 8A. The cooling fluid can be supplied to the circuit on a terminal rack (not shown). For simplicity, FIGS. 8A and 8B show only one channel 2. However, it is understood that in a completely mounted condition the stator 25 includes a plurality of channels 2, as described for example in connection with FIG. 6.

1. A conductor to be inserted into a slot of an electrical machine, comprising:
a first winding element made of an electrically conductive material as a hollow conductor with a channel through which a coolant can flow, wherein the first winding element is integrally formed having a first straight portion, a reverse portion and a second straight portion parallel to the first straight portion, wherein the first straight portion has a first end section and the second straight portion has a second end section, and a hollow connecting member made of electrically conductive material, wherein the hollow connecting member and the first end section of the winding element are axially insertable into each other to form an axially overlapping electrical and fluidic connection.

2. The conductor according to claim 1, wherein the hollow connecting member is connected to the first end section of the winding element with an interference fit.

3. The conductor according to claim 1, wherein at least one of the first end section and the second end section has a connecting bore extending from the end face of the winding element to a stop face and having a greater cross section than the channel.

4. The conductor according to claim 3, wherein the hollow connecting member axially abuts the stop face of the winding element in the inserted condition.

5. The conductor according to claim 4, wherein the hollow connecting member has an outer diameter that is greater than an inner diameter of the channel of the winding element.

6. The conductor according to claim 1, wherein the hollow connecting member has a smallest inner diameter which is greater than 0.9 times a smallest inner diameter of the channel of the winding element.

7. The conductor according to claim 1, wherein an axial length of the hollow connecting member is at least 0.1 times the length of the first straight portion of the winding element.

8. The conductor according to claim 1, wherein at least one of the hollow connecting member and the winding element is produced from copper, aluminum, stainless steel or an alloy comprising at least one of copper, aluminum and stainless steel.

9. The conductor according to claim 1, wherein the materials of the hollow connecting member and the winding element are selected such that a difference between the thermal expansion coefficient of the material of the hollow connecting member and the thermal expansion coefficient of the material of the winding element is smaller than 10%.

10. The conductor according to claim 1, wherein a second winding element is provided that has the same structure as the first winding element, wherein the first winding element and the second winding element are connected with each other via the hollow connecting member which on one side is axially inserted into the first end section of the first winding element and on the other side is axially inserted into the second end section of the second winding element.

11. The conductor according to claim 10, wherein the conductor is composed of a plurality of first and second winding elements that are connected to each other via a plurality of hollow connecting members, wherein the conductor forms a continuous cooling channel with an inlet and an outlet.

12. The conductor according to claim 1, wherein the first winding element is connected via the hollow connecting member with a straight intermediate element, with one side of the hollow connecting member axially inserted into an end section of the first winding element and the other side of the hollow connecting member axially inserted into the straight intermediate element, and wherein the straight intermediate element is connected via a second hollow connecting member with a second winding element.

13. The conductor according to claim 1 mounted in an electric machine, with the electric machine comprising a stator and a rotor, wherein the stator comprises stator core with a plurality of longitudinal slots distributed over the circumference, with a plurality of conductors being arranged in each one of the longitudinal slots of the stator core for generating an electromagnetic field, wherein at least two of the plurality of conductors are configured with a hollow conductor and a hollow connecting member.

14. The conductor according to claim 13, wherein the stator comprises at least four conductor lines in each slot, wherein at least two of the plurality of conductor lines are configured to be solid conductors.

15. The conductor according to claim 13, wherein the hollow connecting members of the plurality of conductors are arranged in a center plane arranged between a first end face and an opposite second end face of the stator core.
